(19) United States
(12) Patent Application Publication
(10) Pub. No.: US 2012/0089433 A1
(43) Pub. Date: Apr. 12, 2012

(54) METHOD OF PROVIDING USER INFORMATION AND DEVICE ADOPTING THE METHOD

(75) Inventors: Ji-young Kwahk, Gyeonggi-do (KR); Giang-yoon Kwon, Seoul (KR); Jin-young Jeon, Seoul (KR); Sang-woong Hwang, Gyeonggi-do (KR); Jee-sun Yoon, Seoul (KR)

(73) Assignee: SAMSUNG ELECTRONICS CO., LTD, Gyeonggi-do (KR)

(21) Appl. No.: 13/377,446

(22) PCT Filed: Jun. 9, 2010
(86) PCT No.: PCT/KR2010/003704

§ 371 Date: Dec. 9, 2011

(30) Foreign Application Priority Data
Jun. 9, 2009 (KR) 10-2009-0050853
Dec. 14, 2009 (KR) 10-2009-0124065

(51) Int. Cl. G06Q 10/10; G06F 3/01

(52) U.S. Cl. 705/7.15; 715/753; 715/758

(57) ABSTRACT

A method of providing user information and a device adopting the method are provided. In the method, a user list, in which a plurality of users are listed, and user cards of some of the plurality of users listed in the user list are displayed according to the users. Therefore, a user easily checks and applies a network of users even in a complicated network environment.

### PRIORITY

This application is a National Stage of International Application No. PCT/KR2010/003704, filed Jun. 9, 2010, and claims priority from Korean Patent Application Nos. 10-2009-0050853 and 10-2009-0124065 filed on Jun. 9, 2009 and Dec. 14, 2009, respectively, in the Korean Intellectual Property Office, the entire disclosure of each of which are incorporated herein by reference.

### BACKGROUND OF THE INVENTION

1. Field of the Invention

The present invention relates generally to a method of providing user information and a device adopting the method, and more particularly, to a method of providing user information to allow a user to refer to and use information about the user and information about other users and a device adopting the method.

2. Description of the Related Art

Connections among devices through a network may be ultimately regarded as connections among users who have accessed the devices connected to one another through the network. In reality, a user is more interested in a network of users of devices than a network of the devices.

One user uses one device, but several users may share one device. Also, devices may be intricately connected to one another through a network. This makes a network of users more complicated. Accordingly, a method of allowing a user to easily check and apply a network of users even in a complicated network environment is required.

### SUMMARY OF THE INVENTION

The present invention provides a method of providing user information, by which a user list including a plurality of users and user cards of some of the plurality of users of the user list are displayed on a display according to the users to allow a user to further easily check and apply a network of the users even in a complicated network environment.

The present invention also provides a method of providing user information, by which user cards including items related to users selected from a plurality of users are displayed according to the users.

The present invention also provides a device adopting the above methods.

According to an embodiment of the present invention, a user list including a plurality of users and user cards of some of the plurality of users of the user list may be displayed on a display according to the users. Therefore, a user may easily check and apply a network of the users even in a complicated network environment. Here, the applications of the network may include checking of detailed user information, a transmission of a user command, a transmission of contents to a device accessed by the user, etc.

According to an aspect of the present invention, there is provided a method of providing user information. The method includes displaying a user list, in which a plurality of users are listed, on a display; and displaying user cards of some of the users listed in the user list according to the users.

According to another aspect of the present invention, there is provided a device including a display and a controller which displays a user list, in which a plurality of users are listed, on the display and displays user cards of some of the users listed in the user list according to the users.

According to another aspect of the present invention, there is provided a method of providing user information. The method includes selecting some of a plurality of users; and displaying user cards, in which items related to the selected users are recorded, according to the users.

According to another aspect of the present invention, there is provided a device including a display; and controller which displays user cards, which items related to users selected from a plurality of users are recorded, on the display according to the users.

### BRIEF DESCRIPTION OF THE DRAWINGS

The above and other features and advantages of embodiments of the present invention will be more apparent from the following detailed description taken in conjunction with the accompanying drawings, in which:

FIG. 1 illustrates a concept of a generation of a user list;

FIG. 2 illustrates a concept of a user list including users who access several tabletop devices;

FIG. 3 illustrates a detailed description of a user list;

FIGS. 4 through 7 illustrate a process of revising user information by using a user information revising icon;

FIGS. 8 through 10 illustrate a process of logging out by using a log-out icon to cancel an access to a tabletop device;

FIGS. 11 through 13 illustrate a process of transmitting contents by using an accessing user list;

FIGS. 14 and 15 illustrate a concept of a generation of user cards from an accessing user list;

FIG. 16 illustrates a detailed description of a user card;

FIGS. 17 through 20 illustrate a process of revising user information by using a user information revising icon;

FIGS. 21 through 23 illustrate a process of transmitting contents by using a user card;

FIG. 24 illustrates a description of a function of providing a digital reference record;

FIG. 25 illustrates a description of a function of providing Personal Information Management Systems (PIMSs);

FIG. 26 is a block diagram of a device to which the present invention may be applied; and

FIG. 27 is a flowchart illustrating a control process performed by a controller of FIG. 26.

### DETAILED DESCRIPTION OF EMBODIMENTS OF THE PRESENT INVENTION

Embodiments of the present invention will be described in more detail with reference to the attached drawings. The embodiments disclosed in the specification and structures shown in the drawings are merely exemplary of the present invention, and it should be understood that various variations capable of substituting for the embodiments may exist at the time of filing the application.

In an embodiment of the present invention, a method of providing user information is provided, including an accessing user list, which is a kind of Graphical User Interface (GUI) capable of applying the user information, and user cards. Hereinafter, a process of generating an accessing user list and user cards, structures of the accessing user list and the user cards, and applications of the accessing user list and the user cards will be described in detail.

### 1. Generation of Accessing User List

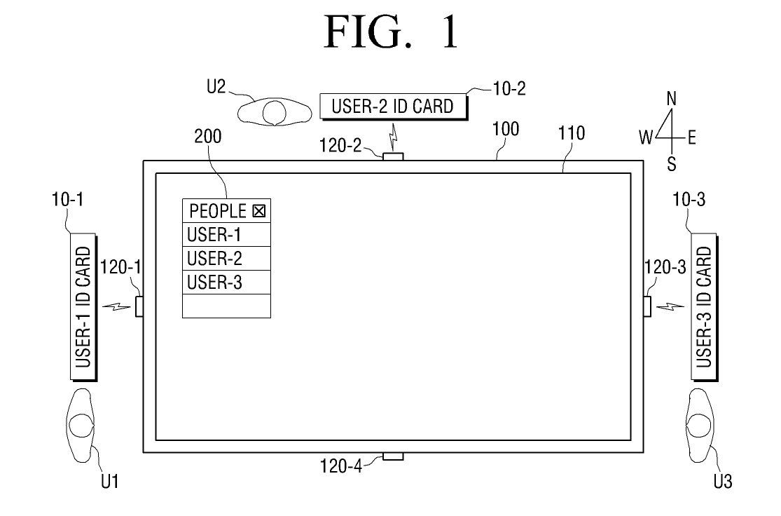

FIG. 1 illustrates a concept of a generation of an accessing user list. A tabletop 100 used in a digital meeting is shown in FIG. 1. As shown in FIG. 1, a touch screen 110 is provided on an upper part of the tabletop device 100, and first through fourth card readers 120-1 through 120-4 are respectively provided on four sides of the tabletop device 100.

A first user U1 accesses a west side of the tabletop device 100 to bring a first Identification (ID) card 10-1 of the first user U1 into contact with the first card reader 120-1 which is provided on the west side of the tabletop device 100. A second user U2 accesses a north side of the tabletop device 100 to bring a second ID card 10-2 of the second user U2 into contact with the second card reader 120-2 which is provided on the north side of the tabletop device 100. A third user U3 accesses an east side of the tabletop device 100 to bring a third ID card 10-3 of the third user U3 into contact with the third card reader 120-3 which is provided on the east side of the tabletop device 100. In this case, the tabletop device 100 recognizes that the first, second, and third users U1, U2, and U3, respectively, have access to information which is recorded in the first, second, and third ID cards 10-1, 10-2, and 10-3, respectively, and read through the first, second, and third card readers 120-1, 120-2, and 120-3, respectively. Also, the tabletop device 100 obtains information about the first, second, and third users U1, U2, and U3 from the information which is recorded in the first, second, and third ID cards 10-1, 10-2, and 10-3 and read through the first, second, and third card readers 120-1, 120-2, and 120-3.

The tabletop device 100 displays an accessing user list 200 on the touch screen 110, wherein the first, second, and third users U1, U2, and U3 who have accessed the tabletop device 100 are listed in the accessing user list 200.

Users who have accessed the tabletop device 100 are listed in the accessing user list 200 shown in FIG. 1. However, users who have accessed several tabletop devices may be listed in a user list.

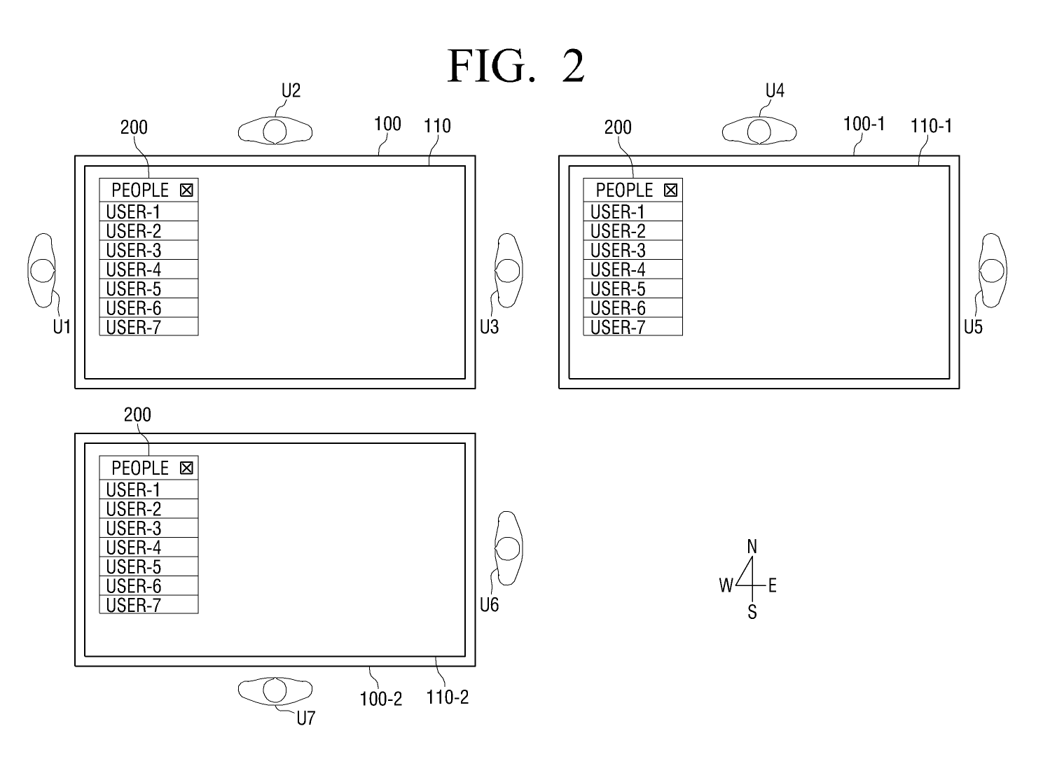

A plurality of tabletop devices 100, 100-1, and 100-2 are shown in FIG. 2. Referring to FIG. 2, first, second, and third users U1, U2, and U3 access the tabletop device 100. Also, fourth and fifth users U4 and U5, respectively, access the tabletop device 100-1, and sixth and seventh users U6 and U7, respectively, access the tabletop device 100-2.

Although not shown in FIG. 2, the tabletop devices 100, 100-1, and 100-2 are connected to one another to communicate with one another through a network. The network may be a wired or a wireless network. Therefore, the tabletop devices 100, 100-1, and 100-2 transmit and receive data with one another.

The tabletop devices 100, 100-1, and 100-2 share information about users, who have accessed them, with the other tabletop devices. Therefore, an accessing user list 200 may be displayed on touch screens 110, 110-1, and 110-2 of the tabletop devices 100, 100-1, and 100-2. Here, a user who has accessed one of the tabletop devices 100, 100-1, and 100-2 and users who have accessed the other tabletop devices are listed in the accessing user list 200.

In other words, the first through seventh users U1 through U7, who have accessed all of the tabletop devices 100, 100-1, and 100-2 which are connected to one another through the network, are listed in the accessing user list 200 which is provided by the tabletop devices 100, 100-1, and 100-2 through the touch screens 110, 110-1, and 110-2.

If one of users listed in the accessing user list 200 is touched, a chatting window through which chatting may be performed with the touched user is provided.

### 2. Structure of Accessing User List

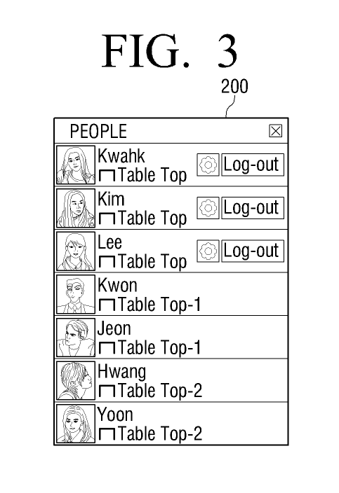

FIG. 3 illustrates a detailed description of an accessing user list. In other words, a structure of an accessing user list 200 is shown in FIG. 3 in detail.

As described above, users are listed in the accessing user list 200. As shown in FIG. 3, listing orders of the users depend on tabletop devices accessed by the users and accessing orders.

In detail, users who have accessed the same tabletop device are listed to neighbor one another. In FIG. 3, users “Kwahk,” “Kim,” and “Lee” who have accessed a tabletop device 100 are listed first. Next, users “Kwon” and “Jeon” who have accessed a tabletop device 100-1 are listed. Users who have accessed a tabletop device 100-2 are listed last.

Also, listing orders of users who have accessed the same tabletop device depend on accessing orders. In other words, a listing order of a user who has first accessed a tabletop device comes first. The accessing orders of the users who have accessed the tabletop device 100 may be same as the listing orders of the users “Kwahk”→“Kim”→“Lee”.

The above-described listing orders of the users are only exemplary. The listing orders may be rearranged according to another standard.

As shown in FIG. 3, user-related items, such as user photographs, user names, names of tabletop devices accessed by the users, user information revising icons ⊚, and log-out icons, etc., appear in the accessing user list 200 according to the users.

The user photographs and user names are information, which is used to distinguish users from the other users.

The names of the tabletop devices accessed by the users correspond to names of tabletop devices, which are currently accessed and used by the users.

As shown in FIG. 3, in the accessing user list 200, the users “Kwahk,” “Kim,” and “Lee” access the tabletop device 100, the users “Kwon” and “Jeon” access the tabletop device 100-1, and the users “Hwan” and “Yoon” access the tabletop device 100-2.

The user information revising icons ⊚ and the log-out icons appear only in some of the users who are listed in the accessing user list 200.

The users in which the user information revising icons ⊚ and the log-out icons appear correspond to users who access a tabletop device including a touch screen on which the accessing user list 200 is displayed.

The accessing user list 200 shown in FIG. 3 is displayed on the touch screen 110 of the tabletop device 100. This is because the user information revising icons ⊚ and the log-out icons appear only in the users “Kwahk,” “Kim,” and “Lee.”

In an accessing user list, which is displayed on a touch screen of the tabletop device 100-1, the user information revising icons ⊚ and the log-out icons will appear only in the users “Kwon” and “Jeon”.

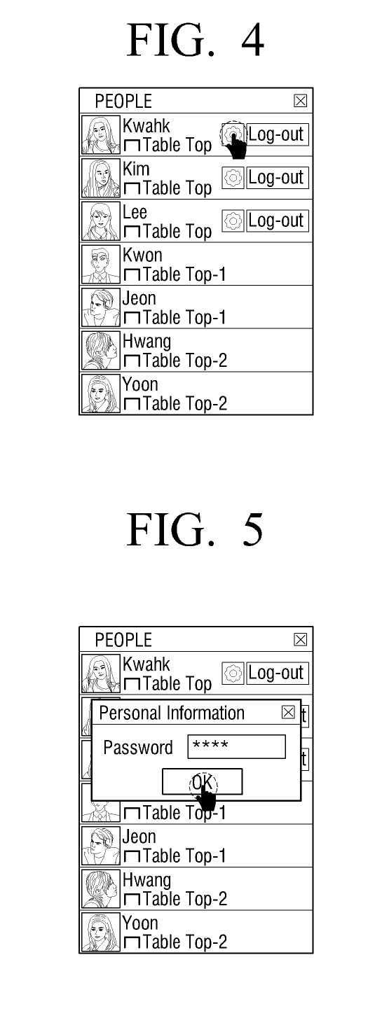

FIGS. 4 through 7 illustrate a process of revising user information by using user information revising icons ⊚.

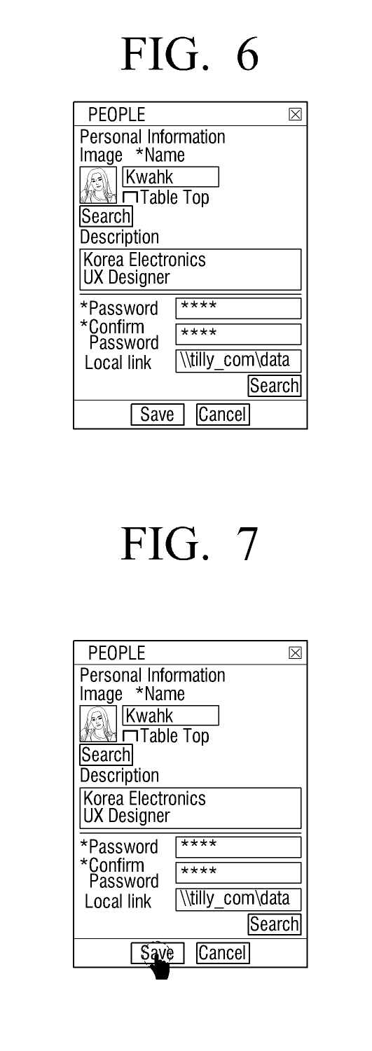

If a user information revising icon of the user “Kwahk” is touched as shown in FIG. 4, an authentication procedure is performed as shown in FIG. 5, and then a user information revising window appears as shown in FIG. 6.

If a save icon is touched after information revising is completed by using a user information revising window as shown in FIG. 7, the tabletop device 100 revises user information about the user “Kwahk” according to contents which have been revised through the user information revising window.

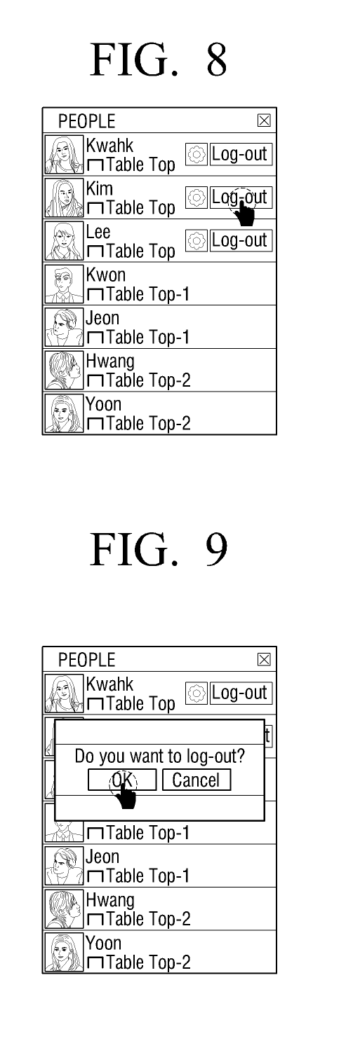

FIGS. 8 through 10 illustrate a process of logging out by using a log-out icon to cancel an access to the tabletop device 100.

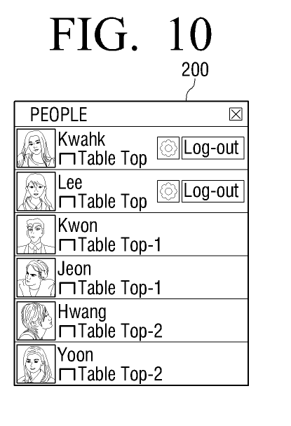

If a log-out icon of the user “Kim” is touched as shown in FIG. 8, the tabletop device 100 performs a confirming procedure as shown in FIG. 9 and then performs log-out processing with respect to the user “Kim.” As a result, as shown in FIG. 10, the user “Kim” is deleted from the accessing user list 200.

### 3. Transmission of Contents by Using Accessing User List

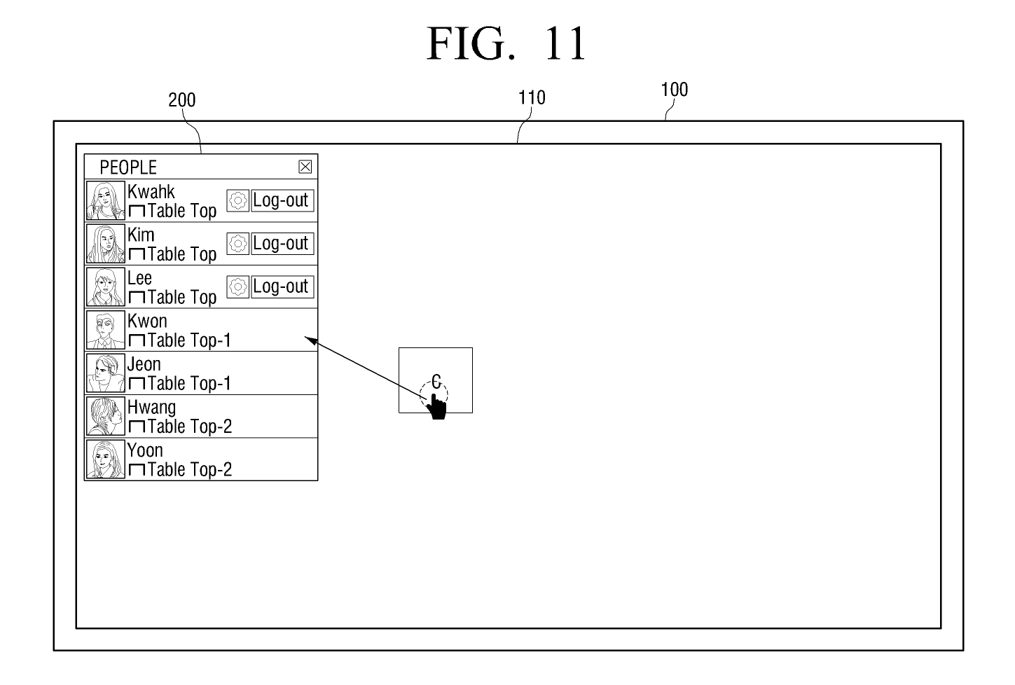

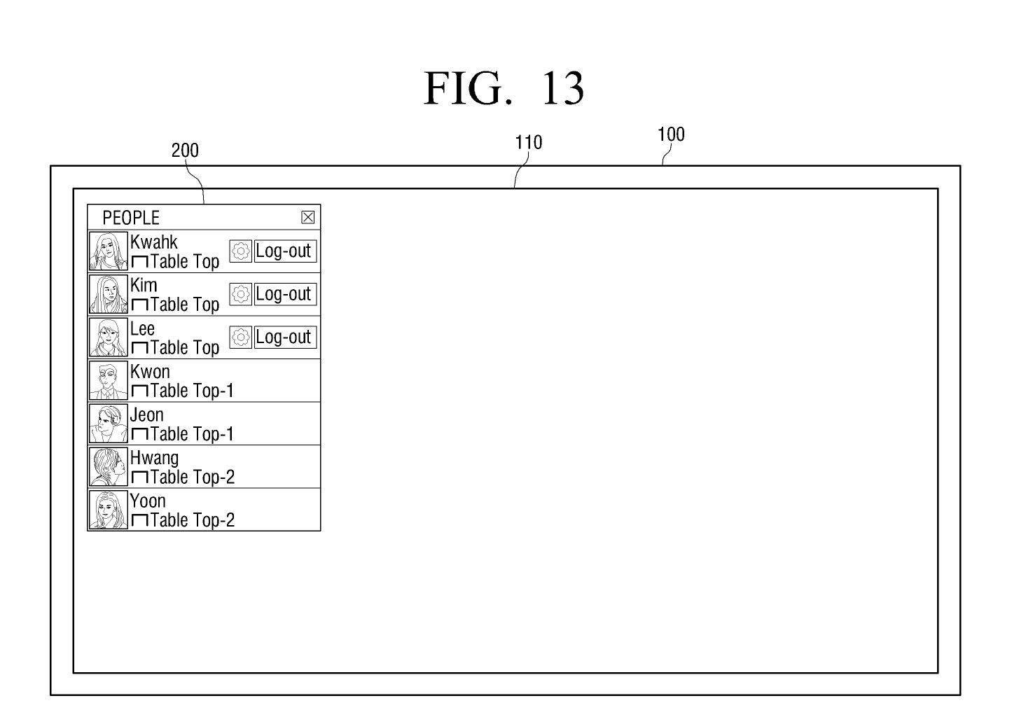

FIGS. 11 through 13 illustrate a process of transmitting contents by using an accessing user list.

As shown in FIG. 11, if contents C displayed on the touch screen 110 are dragged and dropped into the user “Kwon” listed in the accessing user list 200, the tabletop device 100 transmits the contents C to the tabletop device 100-1 accessed by the user “Kwon.”

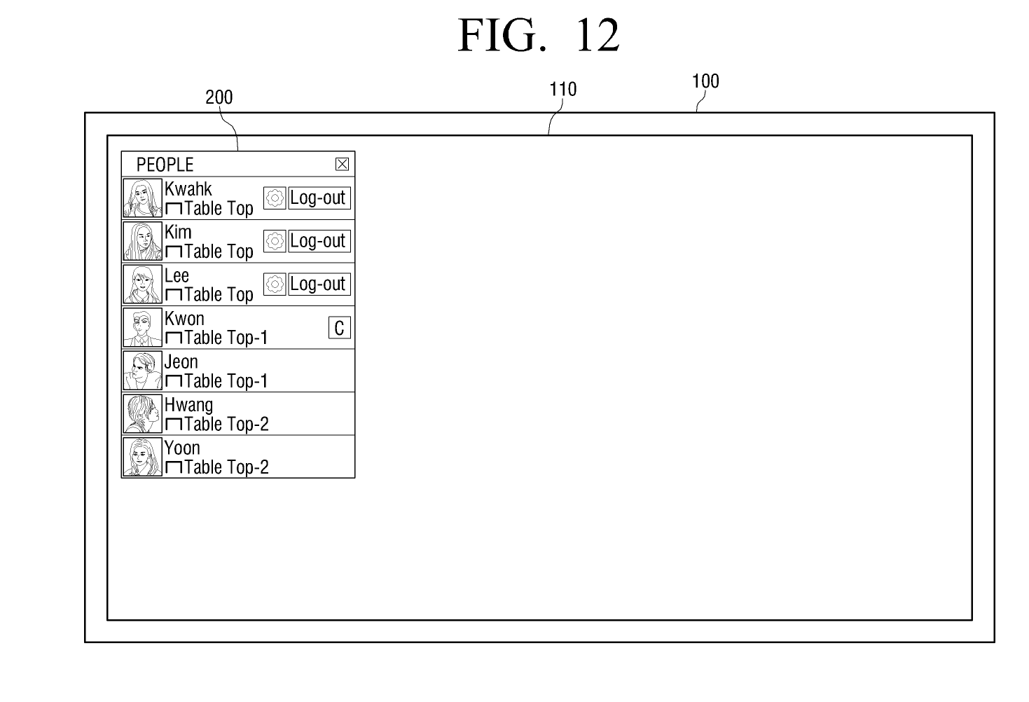

When transmitting the contents C, as shown in FIG. 12, an icon is displayed in the user “Kwon” to indicate the contents C and indicate that the contents C are being transmitted to the user “Kwon.”

If the transmission of the contents C is completed, the tabletop device 100 makes the icon indicating the contents C disappear from the user “Kwon” to indicate that the transmission of the contents C is completed.

The transmitted contents C are not limited. In other words, memoranda written, or pictures drawn, on the touch screen 110 may be transmitted by using the above-described method.

### 4. Generation of User Cards From Accessing User List

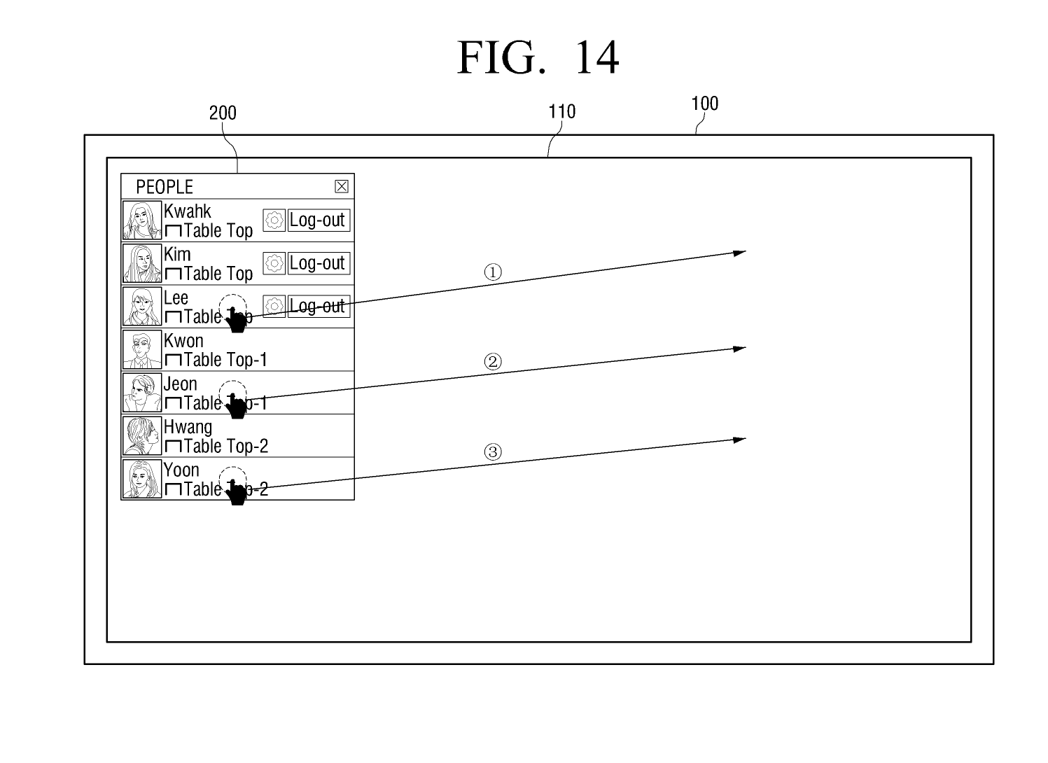

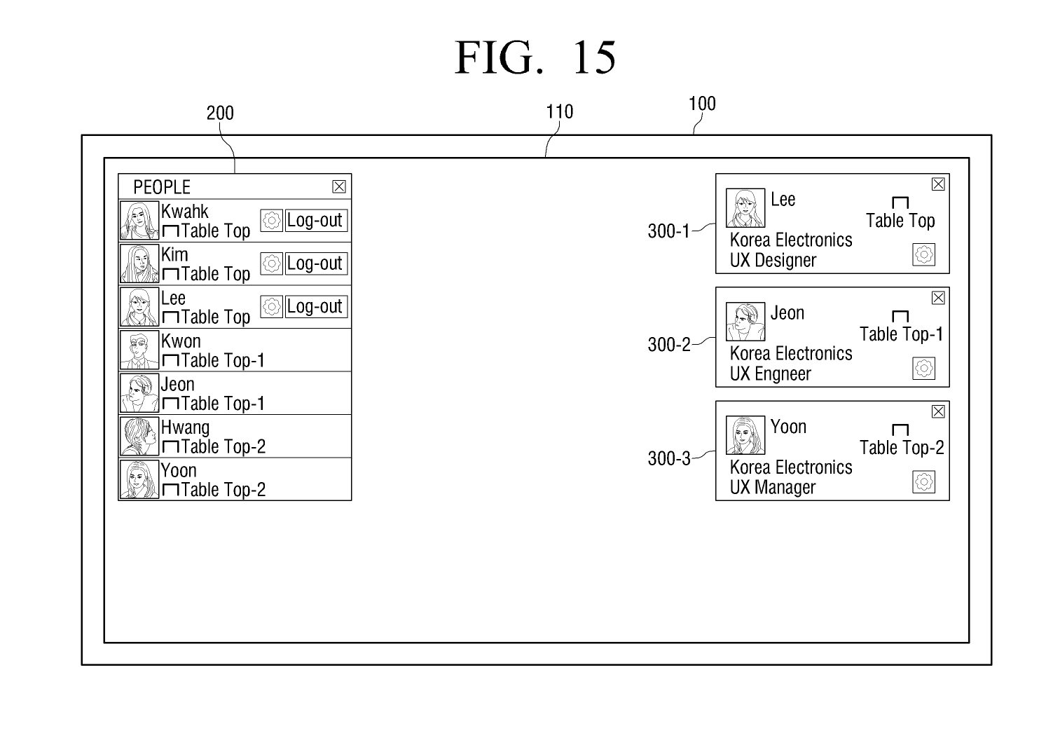

FIGS. 14 and 15 illustrate a concept of a generation of user cards from an accessing user list.

If the users “Lee,” “Jeon,” and “Yoon” listed in the accessing user list 200 are dragged and dropped \textcircled{1}, \textcircled{2}, and \textcircled{3}, respectively, outside the accessing user list 200 as shown in FIG. 14, the tabletop device 100 generates user cards of the users “Lee,” “Jeon,” and “Yoon.”

As shown in FIG. 15, the tabletop device 100 respectively displays generated user cards 300-1, 300-2, and 300-3 in dropped positions.

The user cards 300-1, 300-2, and 300-3 may be dragged and dropped on the touch screen 110. The accessing user list 200 may also be dragged and dropped on the touch screen 110.

Ending icons \textcircled{x} displayed in the user cards 300-1, 300-2, and 300-3 are touched to individually end the user cards 300-1, 300-2, and 300-3, so that the user cards 300-1, 300-2, and 300-3 disappear from the touch screen 110.

An ending icon \textcircled{x} displayed in the accessing user list 200 is touched to end the accessing user list 200. If the accessing user list 200 is ended, all of the user cards 300-1, 300-2, and 300-3 displayed on the touch screen 110 are ended together with the accessing user list 200.

Even if a user logs out by using the accessing user list 200, a user card of the logged out user is ended and disappears.

If one of the user cards 300-1, 300-2, and 300-3 is touched, a chatting window through which chatting may be performed with a user appearing in the touched user card is provided.

### 5. Structure of User Card

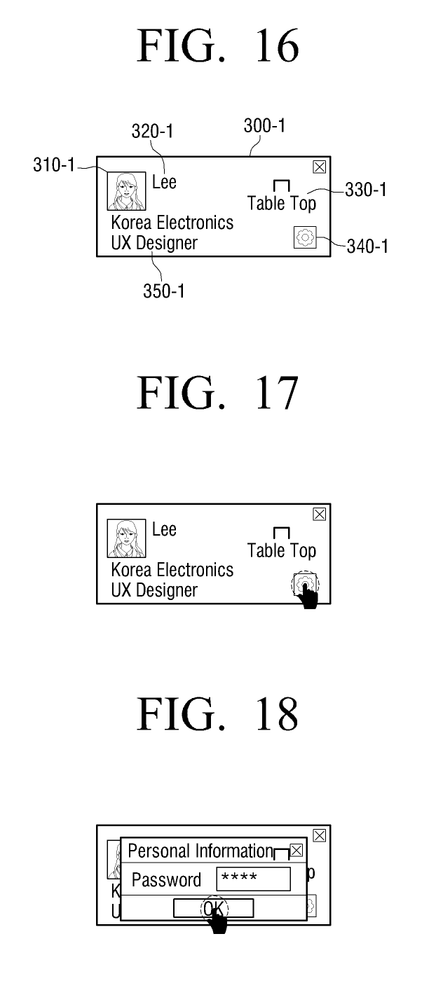

FIG. 16 illustrates a detailed description of a user card. A structure of the user card 300-1 of the user “Lee” is shown in FIG. 16 in detail.

As shown in FIG. 16, the user card 300-1 includes user-related items such as a user photograph 310-1, a user name 320-1, a name 330-1 of a tabletop device accessed by the user, a user information revising icon 340-1, and detailed user information 350-1, etc.

Detailed descriptions of the user photograph 310-1, the user name 320-1, and the name 330-1 of the tabletop device, and the user information revising icon 340-1 are as described above and thus will be omitted.

The detailed user information 350-1 includes detailed information, which is to distinguish a user from the other users, besides the user photograph 310-1 and the username 320-1. A company to which a user belongs and a position of the user in the company are shown as detailed user information in FIG. 16. Other types of information (e.g., contact information, an address, and sex of a user) may be recorded in detailed information of the user.

FIGS. 17 through 20 illustrate a process of revising user information by using the user information revising icon 340-1.

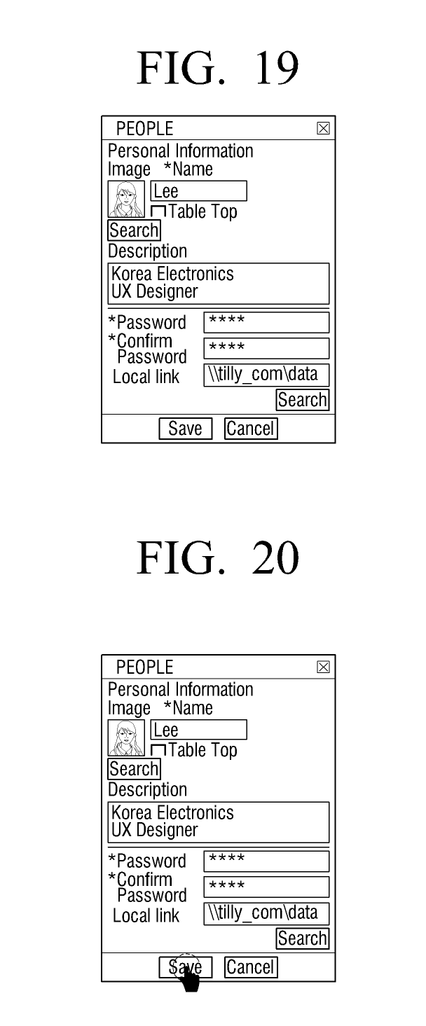

If the user information revising icon 340-1 of the user “Lee” is touched as shown in FIG. 17, an authentication procedure is performed as shown in FIG. 18, and then a user information revising window appears as shown in FIG. 19.

If a save icon is touched as shown in FIG. 20 after information revising is completed by using the user information revising window, the tabletop device 100 revises user information of the user “Lee” according to contents which have been revised through the user information revising window.

### 6. Transmission of Contents by Using User Cards

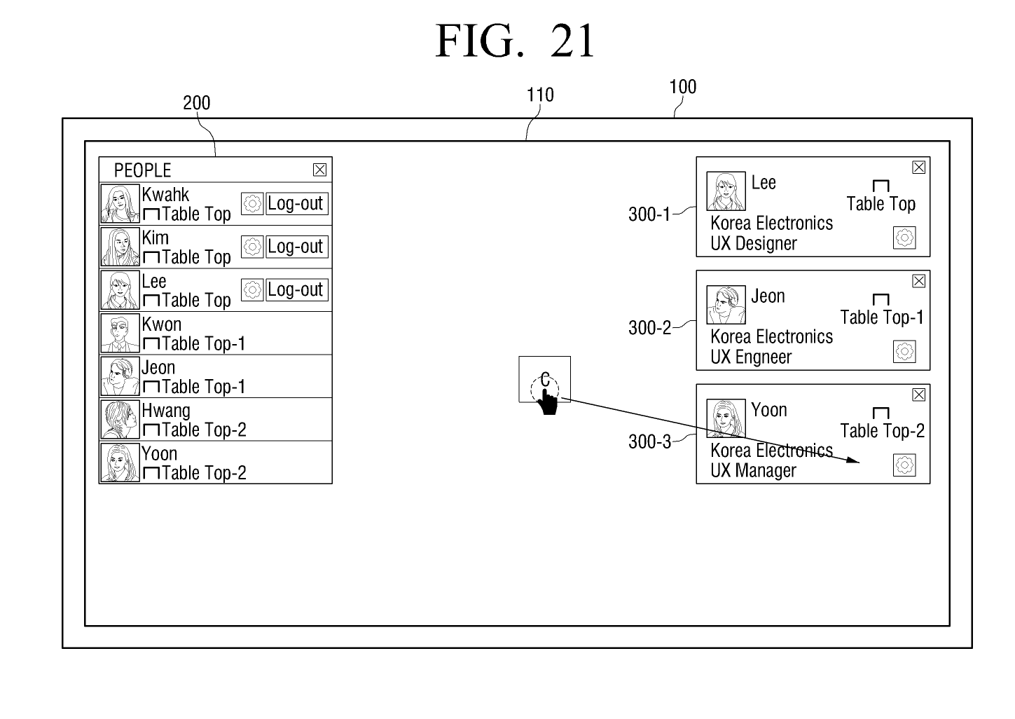

FIGS. 21 through 23 illustrate a process of transmitting contents by using user cards.

If contents C displayed on the touch screen 110 are dragged and dropped into the user card 300-3 of the user “Yoon” as shown in FIG. 21, the tabletop device 100 transmits the contents C to the tabletop device 100-2 accessed by the user “Yoon.”

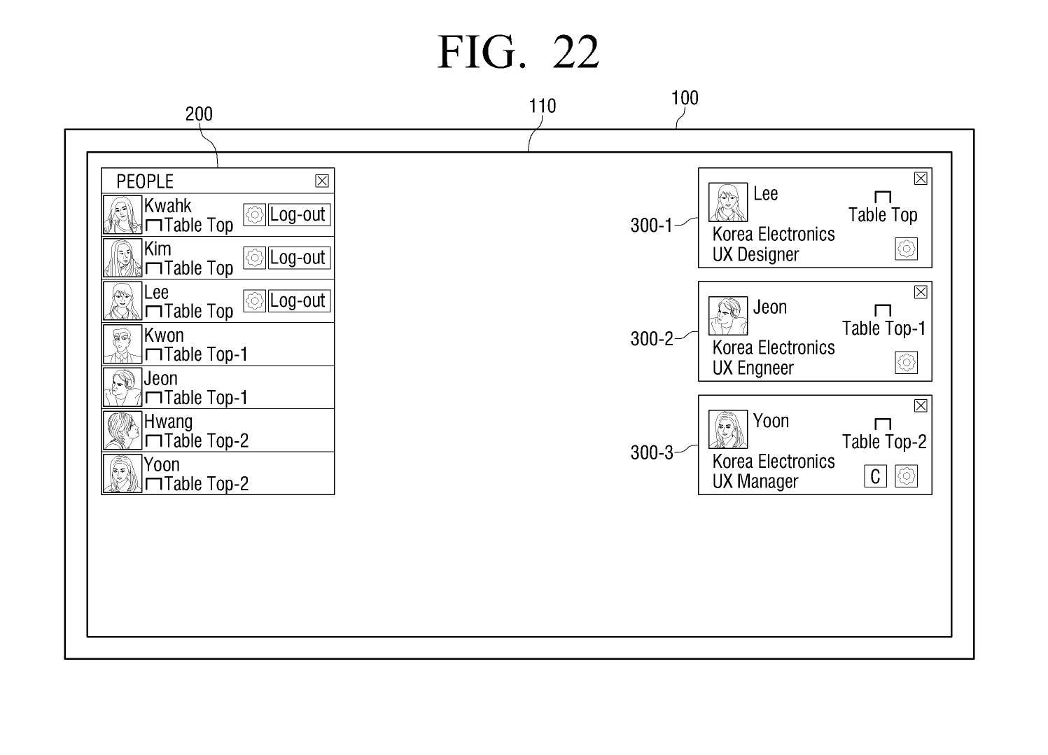

When transmitting the contents C, an icon is displayed to indicate the contents C and indicate that the contents C are being transmitted to the user “Yoon” as shown in FIG. 22.

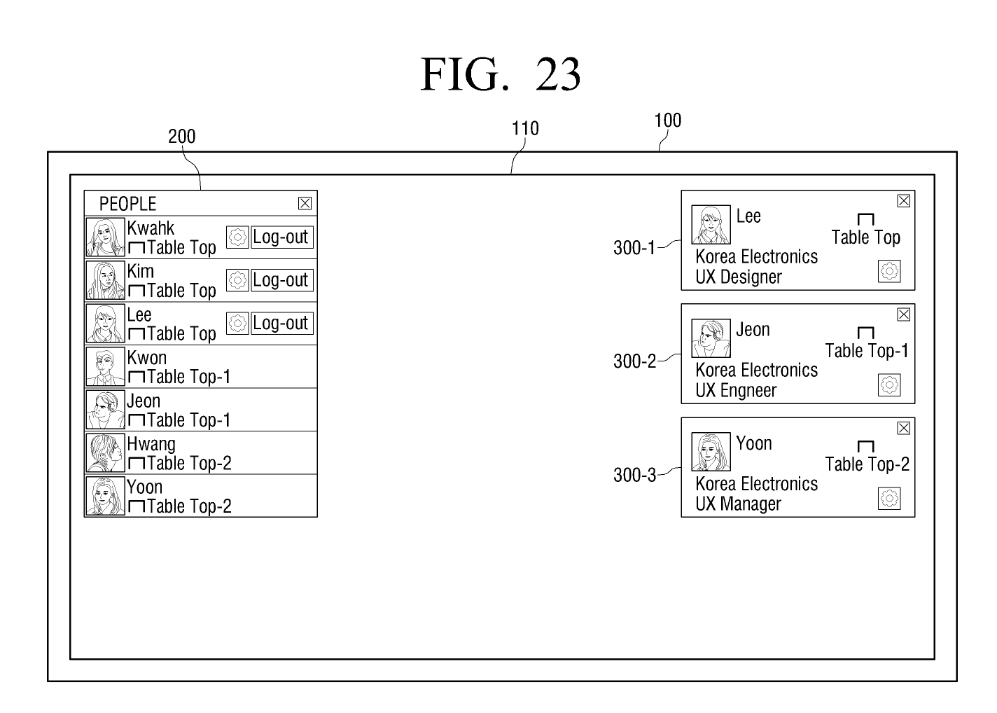

If the transmission of the contents C is completed, the tabletop device 100 makes the icon indicating the contents C disappear from the user card 300-3 of the user “Yoon” as shown in FIG. 23 to indicate that the transmission of the contents C is completed.

The transmitted contents C are not limited. Memoranda written, or pictures drawn, on the touch screen 110 may be transmitted by using the above-described method.

### 7. Subordinate Functions for Digital Meeting

### (1) Function of Providing Digital Meeting Record

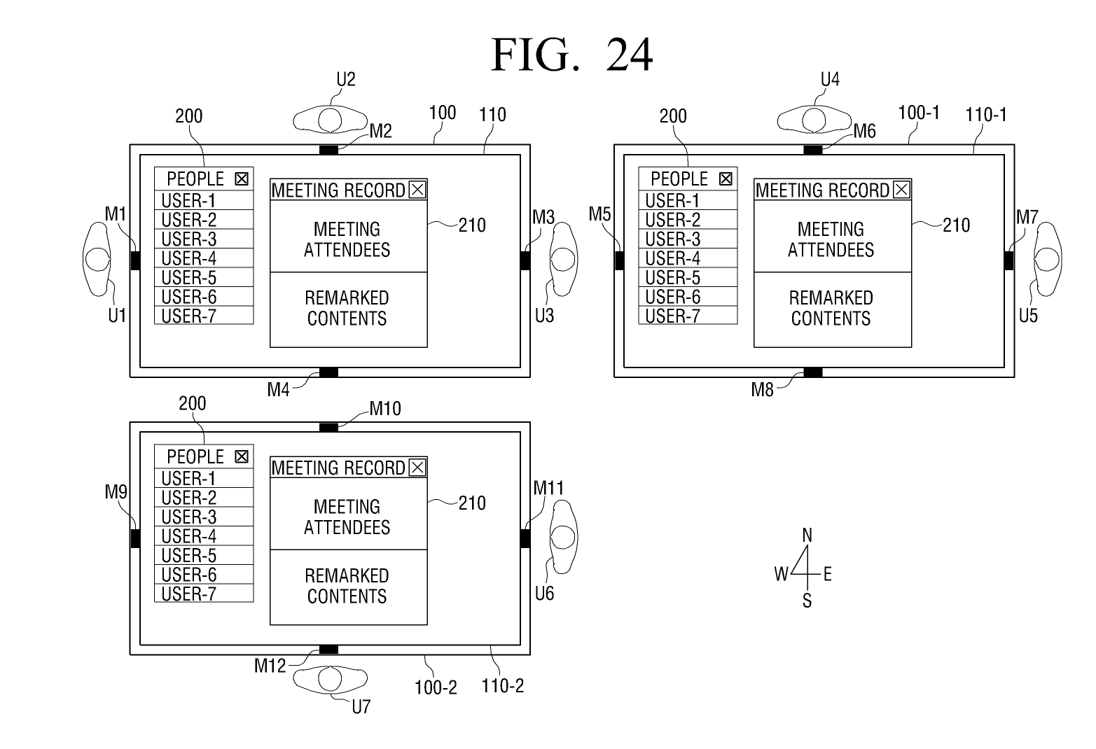

FIG. 24 illustrates a situation in which first through seventh users U1 through U7 hold a digital meeting by using a plurality of tabletop devices 100, 100-1, and 100-2.

Referring to FIG. 24, besides an accessing user list 200, a digital meeting record 210 is further displayed on touch screens 110, 110-1, and 110-2 of the tabletop devices 100, 100-1, and 100-2.

As shown in FIG. 24, the digital meeting record 210 is divided into two areas, i.e., upper and lower areas. Meeting attendees appear in the upper area, and remarked contents provided by the attendees appear in the lower area. Names of the first through seventh users, U1 through U7, attending in a digital meeting are listed in the meeting attendees of the upper area. In the remarked contents, contents remarked by the meeting attendees appear as text along with names of the meeting attendees who have remarked. For example, the remarked contents may appear in a format of “Meeting Attendees' Names: Remarked Contents”

### (2) Function of Providing Personal Information Management Systems (PIMS)

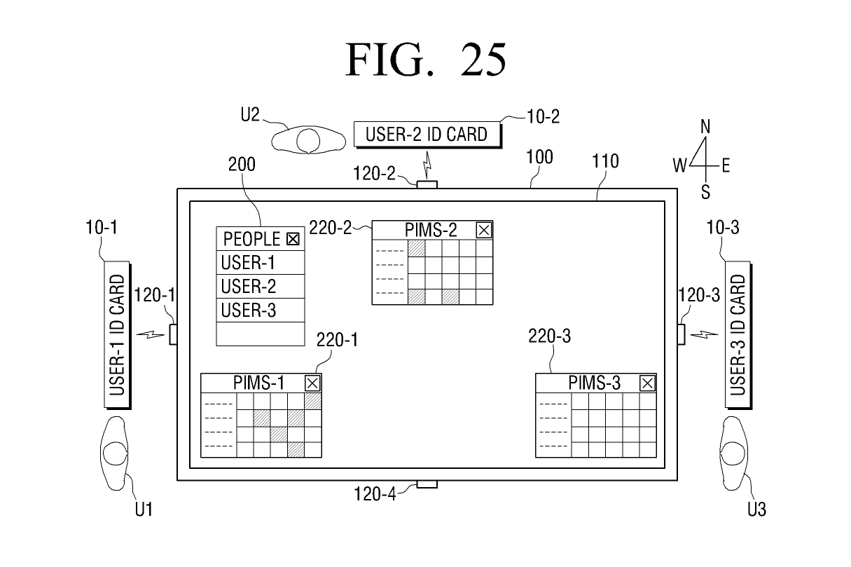

FIG. 25 illustrates a situation in which first through third users U1 through U3 hold a digital meeting by using a tabletop device 100.

Referring to FIG. 25, besides an accessing user list 200, first, second, and third Personal Information Management Systems (PIMSs) 220-1, 220-2, and 220-3, respectively, are displayed on a touch screen 110 of the tabletop device 100.

The first, second, and third PIMSs 220-1, 220-2, and 220-3 record and manage personal information such as schedules and are respectively provided to the first through third users U1 through U3. In other words, the first PIMS 220-1 for the first user U1, the second PIMS 220-2 for the second user U2, and the third PIMS 220-3 for the third user U3 are displayed on the touch screen 110 of the tabletop device 100.

The first, second, and third PIMSs 220-1, 220-2, and 220-3 are provided on the touch screen 110 of the tabletop device 100 in order to immediately record and manage schedules or contents determined in the digital meeting.

The first, second, and third PIMSs 220-1, 220-2, and 220-3 may be stored in the tabletop device 100 and may be transmitted to corresponding users by using the same method as the content transmitting method illustrated in FIGS. 11 through 13 or the content transmitting method illustrated in FIGS. 21 through 23.

Also, the first, second, and third PIMSs 220-1, 220-2, and 220-3 may be transmitted to e-mails of the first through third users U1 through U3.

A digital meeting is held by using one tabletop device in FIG. 25. However, even if a digital meeting is held by using several tabletop devices, PIMSs may be provided.

### 8. Other Modifications

In the above-described embodiments, if users access a tabletop device, an accessing user list is generated and displayed. However, this is only an example and thus may be modified.

If the users access the tabletop device, user cards of the users may be generated or displayed or the accessing user list and the user cards may be displayed together.

Also, user information (photographs, names, and detailed information of the users) is obtained from ID cards of the users. However, the user information may be obtained from other means. For example, the user information may be obtained from personal computers (PCs) of the users, management servers, or a storage medium of the tabletop device.

In addition, among the users listed in the accessing user list, user cards of users who are moved outside the accessing user list are provided. However, this is only an exemplary embodiment for descriptive convenience. A method of selecting the users whose user cards are provided may be realized differently from the above-described method. Also, users whose user cards appear through another means not through an accessing user list may be selected.

Also, in the above-described embodiments, user-related items, such as a user photograph, a user name, information about a device accessed by a user, a user information revising icon, a log-out icon, etc., appear in an accessing user list. User-related items, such as a user photograph, a user name, information about a device accessed by a user, a user information revising icon, detailed user information, etc., appear in a user card.

However, this is only an example, and thus other types of user-related items may be recorded in the accessing user list and the user card. Even in this case, at least one of the user-related items recorded in the accessing user list may be realized to be different from at least one of the user-related items recorded in the user card.

Besides an item indicating information about a user and an icon used to input a user command, other types of items may be recorded in the accessing user list and the user card.

Also, in the above-described embodiments, a user attends a digital meeting through a tabletop device, but this is only an exemplary embodiment. The user may access the tabletop device through a mobile PC of the user to attend the digital meeting.

9. Device to which Embodiments of the Present Invention May Be Applied.

In the above-described embodiments, an accessing user list and user cards are provided in the tabletop device 100. However, embodiments of the present invention may be applied to other types of devices besides the tabletop device. In other words, embodiments of the present invention may be applied to any device which may be shared by several users.

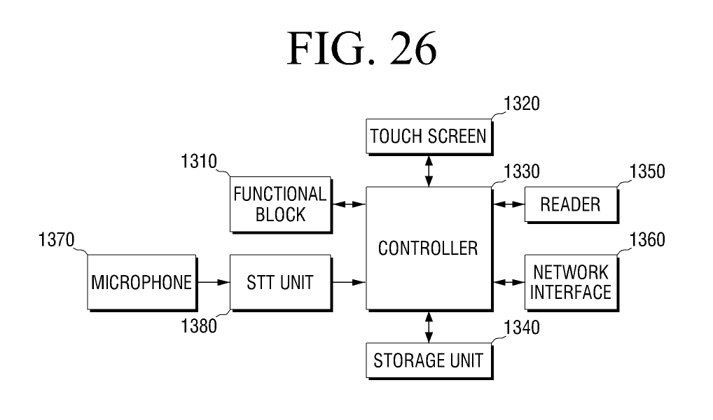

FIG. 26 is a block diagram of a device to which the present invention may be applied. Referring to FIG. 26, the device includes a functional block 1310, a touch screen 1320, a controller 1330, a storage unit 1340, a reader 1350, a network interface 1360, a microphone 1370, and a Speech To Text (STT) unit 1380.

The functional block 1310 performs a function of the device. If the device is a tabletop device, the functional block 1310 performs functions necessary for a digital meeting.

The touch screen 1320 operates as a display, which displays Graphical User Interfaces (GUIs) such as an execution result of the functional block 1310, an accessing user list, and user cards. The touch screen 1320 also operates as a user interface for receiving user commands such as a touch, dragging and dropping, etc.

The storage unit 1340 is a storage medium, which stores user information and contents.

The reader 1350 reads information, which is recorded in a user ID card, and the network interface 1360 communicates with a device, which is connected through a network.

The microphone 1370 generates remarked contents of a user as voice signals and transmits the voice signals to the STT unit 1380.

The STT unit 1380 converts the voice signals received from the microphone 1370 into texts and transmits the texts to the controller 1330.

The controller 1330 provides an accessing user list and user cards as described in the embodiments to a GUI and executes a user command, which is input through the GUI. The controller 1330 also generates a digital meeting record by using the texts received from the STT unit 1380.

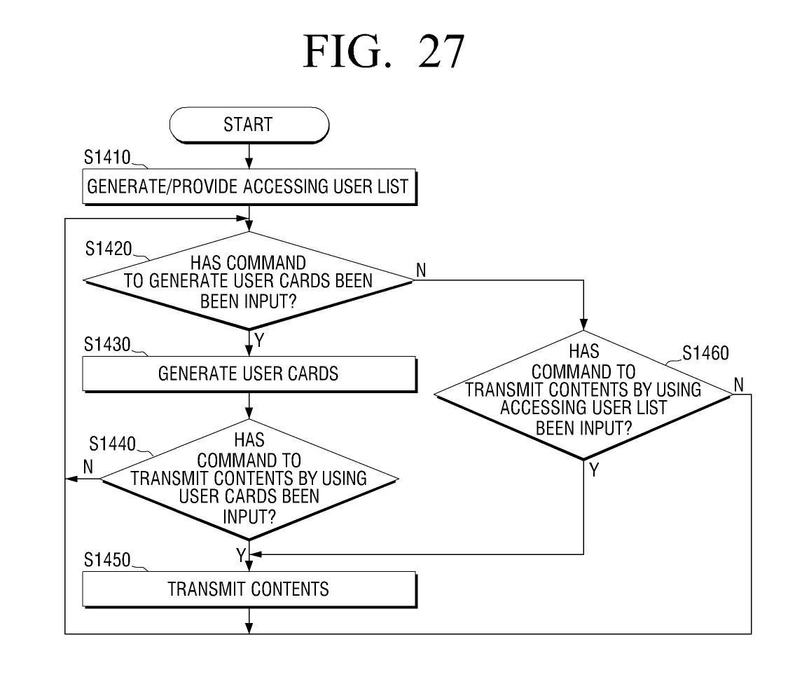

FIG. 27 is a flowchart illustrating a control process performed by the controller 1330. Referring to FIG. 27, in step S1410, the controller 1330 generates an accessing user list based on information about users who access other devices connected through a network and displays the accessing user list on the touch screen 1320.

In step S1420, the controller 1330 determines whether a command to generate user cards has been input from a user. If it is determined in step S1420 that the command has been input from the user, the controller 1330 generates user cards of users selected from the accessing user list and displays the user cards on the touch screen 1320 in step S1430.

In step S1440, the controller 1330 determines whether the users have input commands to transmit contents by using the displayed user cards. If it is determined in step S1440 that the users have input the commands, the controller 1330 transmits contents to tabletop devices, which are designated by the user cards and accessed by the users in step S1450.

In step S1460, the controller 1330 determines whether the users have input commands to transmit contents by using the accessing user list provided in step S1410. If it is determined in step S1460 that the users have input the commands, the controller 1330 goes to step S1450 to transmit the contents to the tabletop devices, which are designated in the accessing user list and accessed by the users.

While the present invention has been particularly shown and described with reference to certain embodiments thereof, it will be understood by those of ordinary skill in the art that various changes in form and details may be made therein without departing from the spirit and scope of the present invention as defined by the following claims.

1. A method of providing user information, the method comprising:
displaying a user list, in which a plurality of users are listed, on a display; and
displaying user cards of at least one of the users listed in the user list according to the users.

2. The method as claimed in claim 1, wherein the at least one user whose user card is displayed are selected from the users listed in the user list.

3. The method as claimed in claim 2, wherein the selected at least one user is a user who has moved outside the user list on the display.

4. The method as claimed in claim 3, wherein the user cards are displayed in positions, which are moved outside the user list on the display.

5. The method as claimed in claim 1, wherein user-related items appear in the user list and the user cards,
wherein at least one of the user-related items appearing in the user list is different from at least one of the user-related items appearing in the user cards.

6. The method as claimed in claim 5, wherein the user-related items appearing in the user list comprise at least one of a user photograph, a user name, information about a device accessed by a user, a user information revising icon, and a log-out icon.

7. The method as claimed in claim 6, wherein at least one of the user information revising icon and the log-out icon appear only in users who access a device which displays the user list.

8. The method as claimed in claim 5, wherein the user-related items appearing in the user list comprise at least one of a user photograph, a user name, information about a device accessed by a user, a user information revising icon, and detailed user information.

9. The method as claimed in claim 1, wherein the users listed in the user list are users who access at least one device connected through a network.

10. The method as claimed in claim 9, wherein the users listed in the user list are users who provide information about the users to at least one device to access the at least one device, wherein the information about the users is recorded in a particular medium.

11. The method as claimed in claim 9, wherein users who access the at least one device are listed in the user list to neighbor one another.

12. The method as claimed in claim 1, further comprising transmitting content to a device accessed by one of the users listed in the user list.

13. The method as claimed in claim 12, wherein the content transmitted to the device accessed by one of the users of the user list who appears in a position into which the content is moved on the display.

14. The method as claimed in claim 13, further comprising displaying information, which indicates that the content is being transmitted, in an area of a user who appears in the position into which the content is moved.

15. The method as claimed in claim 12, wherein the content is manually generated by one of the plurality of users.

16. The method as claimed in claim 1, wherein if the user list ends and disappears from the display, the user cards displayed on the display end along with the user list and disappear from the display.

17. The method as claimed in claim 1, wherein if at least one user logs out by using the user list, the user cards users displayed on the display end and disappear from the display.

18. The method as claimed in claim 1, further comprising if the content displayed on the display is moved into the user card, transmitting the content to a device accessed by the user of the user card into which the content is moved.

19. The method as claimed in claim 18, further comprising displaying information, which indicates that the content is being transmitted, in the user card into which the content is moved.

20. The method as claimed in claim 18, wherein the content is manually generated by one of the plurality of users.

21. The method as claimed in claim 1, further comprising displaying a meeting record of a meeting, which is held by the plurality of users, on the display.

22. The method as claimed in claim 21, wherein in the meeting record, the plurality of users appear as meeting attendees, and content remarked by the meeting attendees appears as text.

23. The method as claimed in claim 22, wherein the remarked content appears along with names of the meeting attendees who provide the remarked content.

24. The method as claimed in claim 1, further comprising providing Personal Information Management Systems (PIMSs) of at least one of the plurality of users according to the users.

25. The method as claimed in claim 24, further comprising transmitting the PIMSs through e-mail according to the users.

26. The method as claimed in claim 1, further comprising providing a chatting window through which chatting is performed with at least one of the plurality of users listed in the user list.

27. A device comprising:
a display; and
a controller which displays a user list in which a plurality of users are listed on the display and displays user cards of at least one of the users listed in the user list according to the users.

28. A method of providing user information, the method comprising:
selecting at least one of a plurality of users; and
displaying user cards, in which items related to the selected user is recorded, according to the users.

29. The method as claimed in claim 28, wherein the items comprise at least one of information about the users and an icon used to input commands of the users.

30. A device comprising:
a display; and
a controller which displays user cards, in which items related to users selected from a plurality of users are recorded, on the display according to the users.
